(19) United States
(12) Patent Application Publication
(10) Pub. No.: US 2005/0109507 A1
(43) Pub. Date: May 26, 2005

(54) Methods of using cement compositions having long-term slurry-state stability

(75) Inventors: James F. Heathman, Katy, TX (US); Timothy T. Quirk, Lafayette, LA (US); Sylvester Auzenne, Lafayette, LA (US)

Correspondence Address: ATTN: CRAIG W. RODDY;HALLIBURTON ENERGY SERVICES GROUP, 2600 SOUTH SECOND STREET, DUNCAN, OK, 73536, US

(73) Assignee: HALLIBURTON ENERGY SERVICES, INC., DUNCAN, OK (US)

(21) Appl. No.: 10/719,647

(22) Filed: Nov. 21, 2003

(51) Int. Cl. C04B 7/32; E21B 33/13

(52) U.S. Cl. 166/292; 106/692; 106/815; 106/802

(57) ABSTRACT

The present invention relates to cementing operations, and more particularly, to cement slurry compositions demonstrating improved long-term slurry-state stability, and methods of using such compositions in subterranean applications. In one embodiment, the present invention provides a method of cementing in a subterranean formation, comprising the steps of: providing a cement composition comprising water, a cement, a set retarder, and a gelation prevention agent, the gelation prevention agent comprising a salt and a calcium sequestering agent; permitting the cement composition to remain in a slurry state for at least twenty-four hours; activating the cement composition at a desired time; placing the cement composition in a subterranean formation; and permitting the cement composition to set therein.

### BACKGROUND OF THE INVENTION

The present invention relates to cementing operations, and more particularly, to cement slurry compositions demonstrating improved long-term slurry-state stability, and methods of using such compositions in subterranean applications.

Hydraulic cement compositions are commonly utilized in subterranean operations, particularly subterranean well completion and remedial operations. For example, hydraulic cement compositions are used in primary cementing operations whereby pipe strings, such as casings and liners, are cemented in well bores. In performing primary cementing, hydraulic cement compositions are pumped into the annular space between the walls of a well bore and the exterior surface of the pipe string disposed therein. The cement composition is permitted to set in the annular space, thereby forming an annular sheath of hardened substantially impermeable cement therein that substantially supports and positions the pipe string in the well bore and bonds the exterior surface of the pipe string to the walls of the well bore. Hydraulic cement compositions also are used in remedial cementing operations such as plugging highly permeable zones or fractures in well bores, plugging cracks and holes in pipe strings, and the like. In certain remedial cementing operations, a hydraulic cement composition may be placed in a desired location within a subterranean formation through the use of a tool referred to as a dump bailer.

Hydraulic cement slurries are often prepared and used within a few minutes, or hours, after preparation. In certain circumstances, however, an operator may find it desirable to prepare a volume of a cement composition that remains in a pumpable state for a long period of time (e.g., for about two weeks or more), and when desired, can be selectively activated to set into a hard mass at a later time. For example, in circumstances where large volumes of cement are utilized (such as in offshore platform grouting), the equipment required for mixing and pumping the requisite large volumes of cement composition may be very expensive, and may be difficult to acquire and assemble at the desired location. The storage of the requisite amount of dry cement prior to use may be another problem. Additionally, mixing and pumping the requisite volume of the cement composition may require an excessively long time, e.g., up to thirty days in some circumstances. In circumstances where cementing operations are carried out at a job site having a relatively small or confined working area, storage of dry cement and mixing and pumping equipment may continue to be problematic, even though smaller volumes of cement may be required.

A conventional attempt to solve these problems has been to provide a cement composition in the form of a premixed slurry, and attempt to maintain the cement composition in the slurry state until it is needed. This has conventionally involved attempting to delay the onset of hydration of the cement composition through the use of set retarders. However, the use of conventionally set-retarded cement compositions may encounter a number of difficulties. Conventional cement compositions comprising set retarders may undergo chemical reactions during storage causing them to slowly evolve calcium, often in the form of an amorphous calcium hydroxide, that is believed to react with other species in the cement composition, thereby causing the cement composition to gel. In some cases, the extent of this gelation is such that the cement composition may become unusable because the resultant increase in its viscosity creates insurmountable difficulty in stirring or in removing the cement composition from storage tanks prior to use. It is further believed that some cement compositions may evolve free calcium during storage, which could react with carbon dioxide in the vapor space of the storage container to form calcium carbonate—a known cement accelerator and gelation promoter. This is problematic because the periodic stirring of the cement composition typically performed in order to maintain uniformity of suspension may cause further entrainment of air, and thus continue to promote such reactions.

One method of solving these problems has been to attempt to redesign or recover the cement composition after the onset of gelation by adding more water, or by treating the cement composition with conventional dispersants, friction reducers, and/or set retarders. However, this has been problematic because such dilution and treatments often cause instability in the cement composition, which may cause solid particles within the composition to fall from suspension (e.g., “excessive sedimentation”), thus requiring the addition of, or increased dosages of, viscosifiers, anti-settling additives, and the like.

Cement compositions comprising cement, water, a salt, a set retarder, and a calcium sequestering agent are known, but their use has been limited to short-term cementing operations, e.g., cementing operations where the cement composition is placed in a subterranean formation within a relatively short time (e.g., 4-6 hours) after its formulation.

### SUMMARY OF THE INVENTION

The present invention relates to cementing operations, and more particularly, to cement slurry compositions demonstrating improved long-term slurry-state stability, and methods of using such compositions in subterranean applications.

An example of a method of the present invention is a method of cementing in a subterranean formation, comprising the steps of: providing a cement composition comprising water, a cement, a set retarder, and a gelation prevention agent, the gelation prevention agent comprising a salt and a calcium sequestering agent; permitting the cement composition to remain in a slurry state for at least twenty-four hours; activating the cement composition; placing the cement composition in a subterranean formation; and permitting the cement composition to set therein.

Another example of a method of the present invention is a method of preventing the onset of gelation in a cement composition, the cement composition comprising water, a cement, and a set retarder, comprising the step of adding a gelation prevention agent to the cement composition, the gelation prevention agent comprising a salt and a calcium sequestering agent.

The features and advantages of the present invention will be readily apparent to those skilled in the art upon a reading of the description of exemplary embodiments, which follows.

### DESCRIPTION OF EXEMPLARY EMBODIMENTS

The present invention relates to cementing operations, and more particularly, to cement slurry compositions demonstrating improved long-term slurry-state stability, and methods of using such compositions in subterranean applications. While the methods of the present invention are useful in a variety of applications, they are particularly useful in subterranean well completion and remedial operations, such as primary cementing, e.g., cementing casings and liners in well bores, including those in production wells, which may include multi-lateral subterranean wells. Certain exemplary embodiments of the present invention involve the use of cement compositions that remain in a slurry state, resistant to gelation, for several weeks or more.

The cement compositions useful in the present invention generally comprise a cement, water sufficient to form a pumpable slurry, a set retarder, and a gelation prevention agent. A wide variety of optional additives may be included in the cement compositions if desired.

Any cements suitable for use in subterranean applications are suitable for use in the present invention. In certain exemplary embodiments, the cement compositions used in the present invention comprise a hydraulic cement. A variety of hydraulic cements are suitable for use including those comprised of calcium, aluminum, silicon, oxygen, and/or sulfur, which set and harden by reaction with water. Such hydraulic cements include, but are not limited to, Portland cements, pozzolanic cements, gypsum cements, high alumina content cements, silica cements, and high alkalinity cements. Cements comprising vitrified shale or blast furnace slag also may be suitable for use in the present invention.

The water present in the cement compositions used in the present invention may be from any source provided that it does not contain an excess of compounds that adversely affect other compounds in the cement compositions. For example, a cement composition useful with the present invention can comprise fresh water, salt water (e.g., water containing one or more salts dissolved therein), brine (e.g., saturated salt water), or seawater. The water may be present in an amount sufficient to form a pumpable slurry. Generally, the water is present in the cement composition in an amount in the range of from about 15% to about 150% by weight of cement (“bwoc”) therein. In certain exemplary embodiments, the water is present in the cement composition in an amount in the range of from about 25% to about 65% bwoc.

The cement compositions used in the present invention further comprise a set retarder selected from the group consisting of phosphonic acid, phosphonic acid derivatives and borate compounds. In certain exemplary embodiments, the set retarders used in the present invention are phosphonic acid derivatives, such as those described in U.S. Pat. No. 4,676,832, the relevant disclosure of which is hereby incorporated herein. Examples of suitable set retarders include phosphonic acid derivatives commercially available from Monsanto Corporation of St. Louis, Mo. under the tradename “DEQUEST.” Another example of a suitable set retarder is a phosphonic acid derivative commercially available from Halliburton Energy Services, Inc., of Duncan, Okla., under the tradename “MICRO MATRIX CEMENT RETARDER.” Examples of suitable borate compounds include, but are not limited to, sodium tetraborate and potassium pentaborate. A commercially available example of a suitable set retarder comprising potassium pentaborate is available from Halliburton Energy Services, Inc., of Duncan, Okla., under the tradename “Component R.” Generally, the set retarder is present in the cement compositions used in the present invention in an amount in the range of from about 0.1% to about 10% bwoc. In certain exemplary embodiments, the set retarder is present in the cement compositions used in the present invention in an amount in the range of from about 0.5% to about 4% bwoc.

The cement compositions useful with the present invention further comprise a gelation prevention agent. In certain exemplary embodiments of the present invention, the gelation prevention agent prevents undesirable gels from forming within the cement composition, but does not retard the time required for the cement composition to set. The gelation prevention agents used in the present invention comprise a salt and a calcium sequestering agent. The calcium sequestering agent may be any compound whose presence prevents the release of calcium from the cement or sequesters released calcium within the cement, and that does not adversely affect other compounds in the cement compositions. Examples of suitable calcium sequestering agents include, but are not limited to, lignosulfonates, organic acids, and copolymers comprising one or more compounds selected from the group consisting of acrylamide methyl sulfonic acid, acrylic acid, maleic anhydride, and itaconic acid. The preceding list is not intended to be an exhaustive list, but rather is intended merely to provide an illustration of some types of materials that may be suitable for use in accordance with the present invention. Other materials may also be suitable, and one of ordinary skill in the art with the benefit of this disclosure will be able to identify an appropriate calcium sequestering agent for a particular application. An example of a suitable organic acid is commercially available from Halliburton Energy Services, Inc., of Duncan, Okla., under the tradename “HR® 25.” Suitable acrylamide methyl sulfonic acid copolymers are further described in U.S. Pat. Nos. 4,015,991; 4,515,635; 4,555,269; 4,676,317; 4,703,801; 5,339,903; and 6,268,406, the relevant disclosures of which are hereby incorporated herein by reference. A suitable acrylamide methyl sulfonic acid copolymer is commercially available from Halliburton Energy Services, Inc., of Duncan, Okla., under the tradename “HALAD® 344.” Another suitable acrylamide methyl sulfonic acid copolymer is commercially available from Halliburton Energy Services, Inc., of Duncan, Okla., under the tradename “GAS STOP.” Another suitable acrylamide methyl sulfonic acid copolymer is commercially available from Halliburton Energy Services, Inc., of Duncan, Okla., under the tradename “GAS STOP HT.” In certain exemplary embodiments, the calcium sequestering agent comprises an acrylamide methyl sulfonic acid copolymer. In certain exemplary embodiments, the salt is sodium chloride. Generally, the calcium sequestering agent is present within the cement composition in an amount in the range of from about 0.1% to about 5% bwoc, and the salt is present in the cement composition in an amount in the range of from about 1% to about 40% by weight of water (“bwow”).

As will be recognized by those skilled in the art, the cement compositions used in the present invention also can include additional suitable additives, including accelerants, defoamers, bactericides, dispersants, density-reducing additives, fibers, weighting materials, viscosifiers, fly ash, silica, hollow microspheres, and the like. An example of a suitable defoaming agent is commercially available from Halliburton Energy Services, Inc., of Duncan, Okla., under the tradename “D-AIR™ 3000 L.” An example of a suitable viscosifier is a biopolymer commercially available from Kelco Oilfield Group of Houston, Tex., under the tradename “BIOZAN®.” An example of a suitable dispersant is commercially available from Halliburton Energy Services, Inc., of Duncan, Okla., under the tradename “CFR-3.” An example of a suitable bactericide is commercially available from Halliburton Energy Services, Inc., of Duncan, Okla., under the tradename “BE-6.” Any suitable additive may be incorporated within the cement compositions used in the present invention. One of ordinary skill in the art with the benefit of this disclosure will be able to recognize where a particular additive is suitable for a particular application.

In an exemplary embodiment of a method of the present invention, the cement compositions useful in the present invention are permitted to remain in a slurry state for at least twenty-four hours before being activated through the addition of an activator, after which the cement composition may be introduced into the subterranean formation. The activator may be added to the cement composition in a variety of ways. For example, the cement composition may be placed into a batch mixer, whereupon the activator may be added, after which the cement composition may be placed into the subterranean formation at a later time. In an exemplary embodiment of the present invention, an activator may be added to the cement composition as it is pumped into the subterranean formation, e.g., by injecting the activator into the cement composition flow stream as the cement composition is pumped into the formation. One of ordinary skill in the art, with the benefit of this disclosure, will be able to identify suitable metering methods and equipment to add the activator. Examples of suitable activators include, but are not limited to: amine compounds; and salts comprising calcium, sodium, magnesium, aluminum, or a mixture thereof. An example of a suitable calcium salt is calcium chloride. Examples of suitable sodium salts are sodium chloride and sodium aluminate. An example of a suitable magnesium salt is magnesium chloride. Examples of suitable amine compounds are triethanol amine and diethanol amine. Generally, the activator may be added to the cement compositions used with the present invention in an amount in the range of from about 0.1% to about 8% bwoc. In certain exemplary embodiments, the activator may be added to the cement compositions used with the present invention in an amount in the range of from about 1% to about 4% bwoc.

An example of a cement composition useful in accordance with the present invention comprises: a hydraulic cement, 41% water bwoc, 18% sodium chloride bwow, 0.5% of a HALADS 344 additive bwoc, and 4% MICRO MATRIX CEMENT RETARDER bwoc.

An example of a method of the present invention is a method of cementing in a subterranean formation, comprising the steps of: providing a cement composition comprising water, a cement, a set retarder, and a gelation prevention agent, the gelation prevention agent comprising a salt and a calcium sequestering agent; permitting the cement composition to remain in a slurry state for at least twenty-four hours; activating the cement composition; placing the cement composition in a subterranean formation; and permitting the cement composition to set therein. In certain exemplary embodiments of the present invention, the cement composition may be permitted to remain in a slurry state for at least forty-eight hours; in certain other exemplary embodiments, the cement composition may be permitted to remain in a slurry state for up to about two weeks; in other exemplary embodiments, the cement composition may be permitted to remain in a slurry state for more than two weeks. In certain exemplary embodiments, the cement composition is placed in the subterranean formation through the use of a dump bailer.

Another example of a method of the present invention is a method of preventing the onset of gelation in a cement composition, the cement composition comprising water, a cement, and a set retarder, comprising the step of adding a gelation prevention agent to the cement composition, the gelation prevention agent comprising a salt and a calcium sequestering agent. Additional steps may include, for example, permitting the cement composition to remain in a slurry state for at least twenty-four hours.

To facilitate a better understanding of the present invention, the following illustrative examples of some of the preferred exemplary embodiments are given. In no way should such examples be read to limit the scope of the invention.

### EXAMPLE 1

A sample cement composition was prepared in accordance with API Recommended Practice 10B. Sample Composition No. 1 comprised 372 grams of water, to which 0.11 grams of BE-6, 2.5 grams of CFR-3, and 5 grams of a HALAD® 344 additive were added. About 1,000 grams of Portland cement were added, and sheared at 12,000 rpm for approximately 35 seconds. Then, about 10.19 grams of MICRO MATRIX CEMENT RETARDER were added, after which point the mixture was stirred for 30 seconds at 3,000 rpm.

Sample Composition No. 1 was then divided in half, and the initial properties of each of the two portions were recorded. The two portions were placed into glass jars and tightly sealed, before being placed in a 100° F. water bath. Every 24 hours, one portion was stirred with a spatula, after which its rheology was tested on a rotational viscometer. This process was repeated daily for 14 days, or until one portion was deemed a failure, or until no significant changes were noted for 3 consecutive days. The results of the testing are summarized in Table I below.

TABLE 1

| | | % | % | Rotational Rheometer Data | | | | | | |
|---|---|---|---|---|---|---|---|---|---|---|
| Day | State | Separation | Settling | 100 | 60 | 30 | 10 | 6 | 3 | Comments |
| Initial | Fluid | Trace | None | 96 | 64 | 36 | 16 | 12 | 8 | |
| 1 | Fluid | Trace | None | 112 | 76 | 44 | 18 | 12 | 8 | |
| 2 | Fluid | Trace | None | 160 | 110 | 66 | 30 | 20 | 14 | |
| 3 | Fluid | Trace | None | 176 | 124 | 76 | 38 | 26 | 18 | |
| 4 | Fluid | Trace | None | 212 | 170 | 116 | 70 | 60 | 46 | Very viscous |
| 5 | Gelled | Trace | None | 240 | 188 | 134 | 80 | 76 | 62 | Difficult to stir |
| 6 | Gelled | Trace | None | 268 | 214 | 160 | 140 | 104 | 92 | Very difficult |
| | | | | | | | | | | to stir |

| | | | | |
|---|---|---|---|---|
| 7 | Gelled | Trace | None | Slurry too thick to test |

The above example demonstrates, inter alia, the progressive gelation properties of conventional cement compositions.

### EXAMPLE 2

A sample cement composition was prepared in accordance with API Recommended Practice 10B. Sample Composition No. 2 comprised 474 grams of water, to which 0.13 grams of BE-6, 2.96 grams of D-AIR 3000 L, 3 grams of CFR-3, 6 grams of a HALAD® 344 additive, 93.06 grams of sodium chloride and 3 grams of HR® 25 were added. About 1,200 grams of Portland cement were added, and sheared at 12,000 rpm for approximately 35 seconds. Then, about 48.92 grams of MICRO MATRIX CEMENT RETARDER were added, after which point the mixture was stirred for 30 seconds at 3,000 rpm.

Sample Composition No. 2 was then divided in half, and the initial properties of each of the two portions were recorded. The two portions were placed into glass jars and tightly sealed, before being placed in a 100° F. water bath. Every 24 hours, one portion was stirred with a spatula, after which its rheology was tested on a rotational viscometer; every 24 hours, the other portion was checked with a shearometer, but not stirred. On the shearometer, “pass” designates a value of less than 100 lb/100 ft². This process was repeated daily for 14 days, or until one portion was deemed a failure, or until no significant changes were noted for 3 consecutive days. The results of the testing are summarized in Table 2 below.

TABLE 2

| | | % | | | | | | | | |
|---|---|---|---|---|---|---|---|---|---|---|
| | | Sepa- | % | Rotational Rheometer Data | | | | | | Shearo- |
| Day | State | ration | Settling | 100 | 60 | 30 | 10 | 6 | 3 | meter |
| Initial | Fluid | None | None | 62 | 46 | 32 | 20 | 16 | 14 | Pass |
| 1 | Fluid | Trace | None | 76 | 56 | 36 | 20 | 16 | 12 | Pass |
| 2 | Fluid | 4.20% | None | 74 | 52 | 34 | 18 | 14 | 12 | Pass |
| 3 | Fluid | 4.20% | None | 48 | 32 | 22 | 12 | 10 | 8 | Pass |
| 4 | Fluid | 4.20% | None | 74 | 50 | 32 | 16 | 14 | 10 | Pass |
| 5 | Fluid | 4.20% | None | 66 | 46 | 28 | 16 | 12 | 12 | Pass |
| 6 | Fluid | 4.20% | None | 42 | 30 | 20 | 12 | 8 | 8 | Pass |
| 7 | Fluid | 4.20% | None | 56 | 40 | 26 | 14 | 12 | 10 | Pass |
| 8 | Fluid | 4.20% | None | 56 | 36 | 26 | 12 | 10 | 8 | Pass |
| 9 | Fluid | 4.20% | None | 56 | 38 | 24 | 14 | 8 | 6 | Pass |
| 10 | Fluid | 4.0% | None | 58 | 42 | 28 | 14 | 10 | 8 | Pass |
| 11 | Fluid | 4.0% | None | 62 | 46 | 28 | 14 | 14 | 8 | Pass |
| 12 | Fluid | 4.0% | None | 68 | 46 | 30 | 16 | 14 | 10 | Pass |
| 13 | Fluid | 4.0% | None | 64 | 46 | 30 | 16 | 14 | 10 | Pass |
| 14 | Fluid | 4.0% | None | 64 | 44 | 28 | 16 | 14 | 10 | Pass |

The above example illustrates, inter alia, that the cement compositions used with the present invention resist the onset of gelation for a period of time.

### EXAMPLE 3

A sample cement composition was prepared in accordance with API Recommended Practice 10B. Sample Composition No. 3 comprised 474 grams of water, to which 0.13 grams of BE-6, 2.96 grams of D-AIR 3000 L, 3 grams of CFR-3, 6 grams of a HALAD® 344 additive, and 93.06 grams of sodium chloride were added. About 1,200 grams of Portland cement were added, and sheared at 12,000 rpm for approximately 35 seconds. Then, about 48.92 grams of MICRO MATRIX CEMENT RETARDER were added, after which point the mixture was stirred for 30 seconds at 3,000 rpm.

Sample Composition No. 3 was then divided in half, and the initial properties of each of the two portions were recorded. The two portions were placed into glass jars and tightly sealed, before being placed in a 100° F. water bath. Every 24 hours, one portion was stirred with a spatula, after which its rheology was tested on a rotational viscometer; every 24 hours, the other portion was checked with a shearometer, but not stirred. This process was repeated daily for 14 days, or until one portion was deemed a failure, or until no significant changes were noted for 3 consecutive days. The results of the testing are summarized in Table 3 below.

TABLE 3

| | | % | | | | | | | | |
|---|---|---|---|---|---|---|---|---|---|---|
| | | Sepa- | % | Rotational Rheometer Data | | | | | | Shearo- |
| Day | State | ration | Settling | 100 | 60 | 30 | 10 | 6 | 3 | meter |
| Initial | Fluid | None | None | 54 | 38 | 26 | 16 | 14 | 12 | Pass |
| 1 | Fluid | Trace | None | 70 | 48 | 34 | 20 | 16 | 14 | Pass |
| 2 | Fluid | 4.20% | None | 74 | 52 | 34 | 20 | 16 | 12 | Pass |
| 3 | Fluid | 4.20% | None | 54 | 38 | 26 | 14 | 12 | 10 | Pass |
| 4 | Fluid | 4.20% | None | 60 | 44 | 28 | 18 | 14 | 12 | Pass |
| 5 | Fluid | 4.20% | None | 58 | 40 | 26 | 16 | 12 | 12 | Pass |
| 6 | Fluid | 4.20% | None | 58 | 42 | 28 | 16 | 14 | 12 | Pass |
| 7 | Fluid | 4.20% | None | 58 | 42 | 28 | 16 | 14 | 12 | Pass |
| 8 | Fluid | 4.20% | None | 54 | 40 | 30 | 14 | 10 | 10 | Pass |
| 9 | Fluid | 4.20% | None | 52 | 36 | 32 | 12 | 8 | 6 | Pass |
| 10 | Fluid | 4% | None | 56 | 40 | 24 | 12 | 10 | 6 | Pass |
| 11 | Fluid | 4% | None | 60 | 42 | 24 | 16 | 12 | 12 | Pass |
| 12 | Fluid | 4% | None | 60 | 44 | 28 | 16 | 14 | 12 | Pass |
| 13 | Fluid | 4% | None | 60 | 44 | 28 | 16 | 14 | 10 | Pass |
| 14 | Fluid | 4% | None | 60 | 44 | 28 | 18 | 14 | 12 | Pass |

The above example demonstrates, inter alia, that the cement compositions used with the present invention can resist the onset of gelation for a period of time.

Therefore, the present invention is well adapted to carry out the objects and attain the ends and advantages mentioned as well as those which are inherent therein. While the invention has been depicted, described, and is defined by reference to exemplary embodiments of the invention, such a reference does not imply a limitation on the invention, and no such limitation is to be inferred. The invention is capable of considerable modification, alternation, and equivalents in form and function, as will occur to those ordinarily skilled in the pertinent arts and having the benefit of this disclosure. The depicted and described embodiments of the invention are exemplary only, and are not exhaustive of the scope of the invention. Consequently, the invention is intended to be limited only by the spirit and scope of the appended claims, giving full cognizance to equivalents in all respects.

1. A method of cementing in a subterranean formation, comprising the steps of:
providing a cement composition comprising water, a cement, a set retarder, and a gelation prevention agent, the gelation prevention agent comprising a salt and a calcium sequestering agent;
permitting the cement composition to remain in a slurry state for at least twenty-four hours;
activating the cement composition;
placing the cement composition in a subterranean formation; and
permitting the cement composition to set therein.

2. The method of claim 1 wherein the cement composition is permitted to remain in a slurry state for at least forty-eight hours.

3. The method of claim 1 wherein the cement composition is permitted to remain in a slurry state for about two weeks.

4. The method of claim 1 wherein the cement composition is permitted to remain in a slurry state for more than two weeks.

5. The method of claim 1 wherein the water is fresh water, salt water, brine, sea water, or a mixture thereof.

6. The method of claim 5 wherein the water is present in the cement composition in an amount sufficient to form a pumpable slurry.

7. The method of claim 6 wherein the water is present in the cement composition in an amount in the range of from about 15% to about 150% by weight of the cement.

8. The method of claim 1 wherein the cement is a hydraulic cement selected from the group consisting of: a Portland cement, pozzolanic cement, gypsum cement, high alumina cement, silica cement and a high alkalinity cement.

9. The method of claim 1 wherein the cement comprises vitrified shale or blast furnace slag.

10. The method of claim 1 wherein the set retarder is selected from the group consisting of: phosphonic acid, a phosphonic acid derivative, and a borate compound.

11. The method of claim 1 wherein the borate compound comprises sodium tetraborate or potassium pentaborate.

12. The method of claim 1 wherein the set retarder is present in the cement composition in an amount in the range of from about 0.1% to about 10% by weight of the cement.

13. The method of claim 1 wherein the cement composition further comprises a surfactant, a dispersant, mica, fibers, a bactericide, a formation conditioning agent, a fixed-density weighting agent, fumed silica, bentonite, fly ash, a fluid loss control additive, an expanding additive, a defoamer, a viscosifier, hollow microspheres, or a mixture thereof.

14. The method of claim 1 wherein the salt is sodium chloride.

15. The method of claim 1 wherein the salt is present in the cement composition in an amount in the range of from about 1% to about 40% by weight of the water.

16. The method of claim 1 wherein the calcium sequestering agent is present in the cement composition in an amount in the range of from about 0.1% to about 5% by weight of the cement.

17. The method of claim 1 wherein the calcium sequestering agent is a lignosulfonate or an organic acid.

18. The method of claim 1 wherein the calcium sequestering agent is a copolymer comprising one or more compounds selected from the group consisting of acrylamide methyl sulfonic acid, acrylic acid, maleic anhydride, and itaconic acid.

19. The method of claim 1 wherein the step of activating the cement composition comprises adding an activator to the cement composition.

20. The method of claim 19 wherein the activator is added to the cement composition in an amount in the range of from about 0.1% to about 8% by weight of the cement.

21. The method of claim 19 wherein the activator is an amine compound.

22. The method of claim 21 wherein the amine compound is triethanol amine, diethanol amine, or a mixture thereof.

23. The method of claim 19 wherein the activator is a salt of a material selected from the group consisting of: calcium, sodium, magnesium, and aluminum.

24. The method of claim 23 wherein the salt is calcium chloride, sodium chloride, sodium aluminate, magnesium chloride, or a mixture thereof.

25. The method of claim 19 wherein the activator is added to the cement composition while the cement composition is being placed into the subterranean formation.

26. The method of claim 25 wherein the activator is injected into the cement composition flow stream while the cement composition is being placed into the subterranean formation.

27. The method of claim 1 wherein the step of placing the cement composition in a subterranean formation comprises the step of using a dump bailer to place the cement composition in a desired location in the subterranean formation.

28. The method of claim 1 wherein the water is present in the cement composition in an amount in the range of from about 15% to about 150% by weight of the cement; wherein the set retarder is selected from the group consisting of: phosphonic acid, a phosphonic acid derivative, and a borate compound; wherein the set retarder is present in an amount in the range of from about 0.5% to about 4% by weight of the cement; wherein the gelation prevention agent comprises a salt and a calcium sequestering agent; wherein the calcium sequestering agent is present in the cement composition in an amount in the range of from about 0.1% to about 5% by weight of the cement; wherein the salt is present in the cement composition in an amount in the range of from about 1% to about 40% by weight of water; wherein the salt is sodium chloride; wherein the calcium sequestering agent is an acrylamide methyl sulfonic acid copolymer.

29. A method of preventing the onset of gelation in a cement composition, the cement composition comprising water, a cement, and a set retarder, comprising the step of adding a gelation prevention agent to the cement composition, the gelation prevention agent comprising a salt and a calcium sequestering agent.

30. The method of claim 29 further comprising the step of permitting the cement composition to remain in a slurry state for at least twenty-four hours.

31. The method of claim 29 further comprising the step of permitting the cement composition to remain in a slurry state for at least forty-eight hours.

32. The method of claim 29 further comprising the step of permitting the cement composition to remain in a slurry state for about two weeks.

33. The method of claim 29 further comprising the step of permitting the cement composition to remain in a slurry state for more than two weeks.

34. The method of claim 29 wherein the water is fresh water, salt water, brine, sea water, or a mixture thereof.

35. The method of claim 29 wherein the water is present in the cement composition in an amount sufficient to form a pumpable slurry.

36. The method of claim 35 wherein the water is present in the cement composition in an amount in the range of from about 15% to about 150% by weight of the cement.

37. The method of claim 29 wherein the cement is a hydraulic cement selected from the group consisting of: a Portland cement, pozzolanic cement, gypsum cement, high alumina cement, silica cement and a high alkalinity cement.

38. The method of claim 29 wherein the cement comprises vitrified shale or blast furnace slag.

39. The method of claim 29 wherein the set retarder is selected from the group consisting of: phosphonic acid, a phosphonic acid derivative, and a borate compound.

40. The method of claim 39 wherein the borate compound comprises sodium tetraborate or potassium pentaborate.

41. The method of claim 29 wherein the set retarder is present in the cement composition in an amount in the range of from about 0.1% to about 10% by weight of the cement.

42. The method of claim 29 wherein the cement composition further comprises a surfactant, a dispersant, mica, fibers, a bactericide, a formation conditioning agent, a fixed-density weighting agent, fumed silica, bentonite, fly ash, a fluid loss control additive, an expanding additive, a defoamer, a viscosifier, hollow microspheres, or a mixture thereof.

43. The method of claim 29 wherein the salt is sodium chloride.

44. The method of claim 29 wherein the salt is present in the cement composition in an amount in the range of from about 1% to about 40% by weight of the water.

45. The method of claim 29 wherein the calcium sequestering agent is present in the cement composition in an amount in the range of from about 0.1% to about 5% by weight of the cement.

46. The method of claim 45 wherein the calcium sequestering agent is a lignosulfonate or an organic acid.

47. The method of claim 45 wherein the calcium sequestering agent is a copolymer comprising one or more compounds selected from the group consisting of acrylamide methyl sulfonic acid, acrylic acid, maleic anhydride, and itaconic acid.

48. The method of claim 29 wherein the water is present in the cement composition in an amount in the range of from about 15% to about 150% by weight of the cement; wherein the set retarder is selected from the group consisting of: phosphonic acid, a phosphonic acid derivative, and a borate compound; wherein the set retarder is present in the cement composition in an amount in the range of from about 0.5% to about 4% by weight of the cement; wherein the gelation prevention agent comprises a salt and a calcium sequestering agent; wherein the calcium sequestering agent is an acrylamide methyl sulfonic acid copolymer; wherein the salt is sodium chloride; wherein the salt is present in the cement composition in an amount in the range of from about 1% to about 40% by weight of the water; wherein the calcium sequestering agent is present in the cement composition in an amount in the range of from about 0.1% to about 5% by weight of the cement.
